(19) United States
(12) Patent Application Publication
(10) Pub. No.: US 2015/0246289 A1
(43) Pub. Date: Sep. 3, 2015

(54) METHOD AND APPARATUS FOR GENERATING A RADIAL TIME SERIES FOR DATA REPRESENTATION

(71) Applicant: Infragistics, Inc., Cranbury, NJ (US)

(72) Inventors: Thomas S. Rausch, Manalapan, NJ (US); Stephen Zaharuk, Bensalem, PA (US)

(21) Appl. No.: 14/633,335

(22) Filed: Feb. 27, 2015

Related U.S. Application Data
(60) Provisional application No. 61/946,152, filed on Feb. 28, 2014.

(51) Int. Cl. A63F 13/812; A63F 13/537; A63F 13/46; A63F 13/35; A63F 13/65; A63F 13/573

(52) U.S. Cl. CPC A63F 13/812; A63F 13/65; A63F 13/573; A63F 13/46; A63F 13/35; A63F 13/537

(57) ABSTRACT

Embodiments of the present invention include a method for visualizing data corresponding to a sporting event, comprising: receiving data corresponding to a sporting event, wherein the data comprises at least time one or more specified times during the sporting event, a magnitude associated with each of the one or more specified times, and a team associated with the magnitude; mapping a total time period captured in the data to polar coordinates, where a beginning of play in the sporting event is zero degrees and an end of play in the sporting event is 360 degrees, the polar coordinates displayed in a radial time series; mapping a maximum of the magnitude to a maximum outward extent; mapping each magnitude at the one or more specified times onto the radial time series at a corresponding degree; distinguishing the magnitude by the team corresponding to the magnitude; and displaying the radial time series.

### CROSS-REFERENCE TO RELATED APPLICATION

This application claims benefit of U.S. Provisional Patent Application Ser. No. 61/946,152, filed Feb. 28, 2014, which is incorporated herein by reference in its entirety.

### BACKGROUND OF THE INVENTION

1. Field of the Invention

Embodiments of the present invention generally relate to data manipulation, and, more specifically, to a method and apparatus for generating a radial time series for data representation.

2. Description of the Related Art

Representing data related to financial transactions, profit reports, sporting events, and the like, are generally limited to tabular charts or the like. In some scenarios, it may be desirable to easily understand the fluctuations of data across a period of time, without losing key aspects of the data changes.

Therefore, there is a need for a method and apparatus for generating a radial time series for data representation in accordance with exemplary embodiments of the present invention.

### SUMMARY OF THE INVENTION

A method for generating an interactions explorer for a user interface prototype comprising detecting one or more prototyping actions while a user creates a user interface prototype, adding the one or more prototyping actions to an interaction hierarchy and generating an interactive visual depiction of the interaction hierarchy.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a radial time series graph generated by the graph module in accordance with exemplary embodiments of the present invention;

FIG. 2 is an illustration of an RTS graph for a football game in accordance with exemplary embodiments of the present inventions; and

FIG. 3 is a flow diagram illustrating a method for generating a radial time series in accordance with exemplary embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method and apparatus for generating a radial time series for data representation.

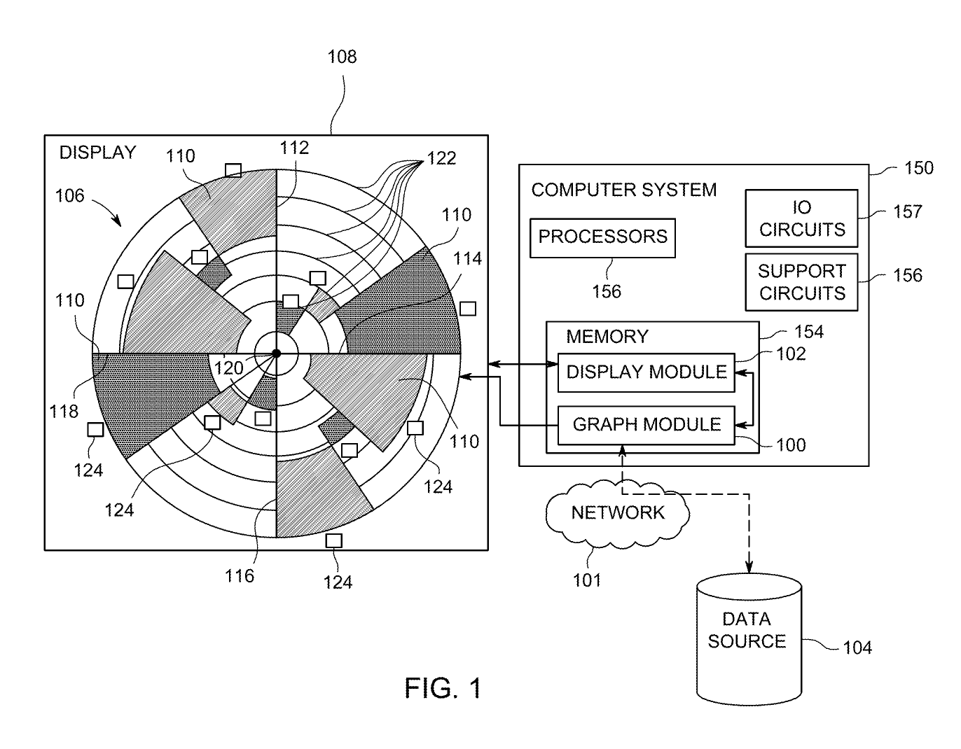

FIG. 1 is an illustration of a radial time series graph generated by the graph module 100 in accordance with exemplary embodiments of the present invention. The graph module 100 receives data from the database 104 across network 101. The graph module 100 processes the data to generate a radial time series representation of that data, e.g., the radial time series graph 106 (referred to as “RTS graph 104”). The graph module 100 is coupled to the display module 102. The display module 102 renders the RTS graph 104 onto a display 108.

Those of ordinary skill will recognize that the database 104, the computer system 150 and the display 108 may be remotely located from each other and coupled via a network 101, locally coupled to each other, or any combination thereof.

The graph module 100 parses the data from the database 104 and maps the various data points onto a radial time series, e.g. The RTS graph 104. In an exemplary embodiment, the RTS graph 104 is circular and begins plotting at 0 to 360 degrees, where 0 degrees is on the quadrant line 112, 90 degrees is on the quadrant line 114, 180 degrees is on the quadrant line 116, 270 degrees is on the quadrant line 118 and 360 degrees is on the quadrant line 112.

Each circle extent 122 radiating outward from the origin point 120 represents a magnitude, where the circle closest to the origin point 120 represents the lowest magnitude of the data, and the circle furthest from the origin point 120 represents the largest magnitude of data. The various sectors 110 represent different actors present in the data and the magnitude associated with those actions. The sectors 110 are arranged temporally. For example, if the data spans 4 weeks, and there are two actors, the actions of the actors is displayed beginning from quadrant line 112 in a radial fashion to quadrant line 114 (e.g., the end of the 1^{st} week mark) to quadrant line 116 (e.g., the end of the 2^{nd} week mark), to quadrant line 118 (e.g., the end of the 3^{rd} week mark), to quadrant line 112 again (e.g., the end of the total period). Accordingly, the total time period covered in the data is mapped to the 360 degrees of the RTS graph 106. Each time period covered in a sector 110 is mapped as percentage of the total time period. For example if one sector has duration of 1 day and four weeks is 28 days, the sector would occupy 1/28^{th} of the entire polar region of RTS 106. If, during that time period, the magnitude value associated with the actor was equal to the maximum value over the entire data set, the sector would radiate outwards towards the furthest circle 122 from the origin point 120. If, during that time period, the magnitude value associated with the actor is not equal to the maximum value, it would extend only proportional to its value out from its beginning point.

In some embodiments, each sector 110 is associated with an identifier 124 (i.e., a label). In some instances, the identifier 124 shows the numerical value of the magnitude associated with the sector 110. In other instances, the identifier 124 may identify a type for the sector 110. In yet other instances, the identifier 124 may indicate an outcome of the period represented by the sector 110.

The display module 102 may also receive input based on interactions with the RTS graph 106. For example, if a user selects a particular sector 110, detailed information corresponding to that sector (e.g., a selected drive in Football) is displayed. Those of ordinary skill in the art will recognize that user input may include the user touching the sector 110, clicking on the sector 110, or the like. The detailed display may pop-up above the RTS graph 106, or opens up as a new display window entirely, according to user preference. The detailed display may be another RTS graph, or may be any other type of illustration, chart, or graph according to exemplary embodiments of the present invention. According to exemplary embodiments, the RTS graph 106 is animated to show various sectors begin and grow as time passes allowing users to observe the growth or reduction of certain actors over time.

According to some embodiments, the graph module 100 converts data from a game into the RTS graph 106. For example, football game data may be annotated and converted into a data file and used to generate the graph. In other instances, soccer games, hockey games, rugby, baseball, basketball or the like, can all be converted into RTS graphs by the graph module 100 by mapping the magnitudes of drives/scores/etc. to circular extents 122 and mapping the game time to the radial polar coordinates of the graph, e.g. 0 minutes would be 0 degrees on the graph 106 while 50 minutes would be 180 degrees on the graph 106 if the total time period for the game was 100 minutes.

The graph module is implemented on the computer system 150 in accordance with exemplary embodiments of the present invention. The computer system 150 includes processors 152, memory 154, various support circuits 156, and input/output circuits 157. The processors 152 may include one or more microprocessors known in the art. The support circuits 156 for the processor 150 include conventional cache, power supplies, clock circuits, data registers, and the like. The I/O circuits 157 may be directly coupled to the memory 154 or coupled through the support circuits 156. The I/O circuits 157 may also be configured for communication with input devices and/or output devices such as network devices, various storage devices, mouse, keyboard, display, video and audio sensors and the like.

The memory 154, or computer readable medium, stores non-transient processor-executable instructions and/or data that may be executed by and/or used by the processor 152. These processor-executable instructions may comprise firmware, software, and the like, or some combination thereof. Modules having processor-executable instructions that are stored in the memory 154 comprise the graph module 100 and the display module 102.

The computer system 150 may be programmed with one or more operating systems, which may include OS/2, Linux, SOLARIS, UNIX, HPUX, AIX, WINDOWS, IOS, and ANDROID among other known platforms. The memory 154 may include one or more of the following: random access memory, read only memory, magneto-resistive read/write memory, optical read/write memory, cache memory, magnetic read/write memory, and the like, as well as signal-bearing media as described below.

Those skilled in the art will appreciate that computer system 150 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 150 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 150 may be transmitted to computer system 150 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

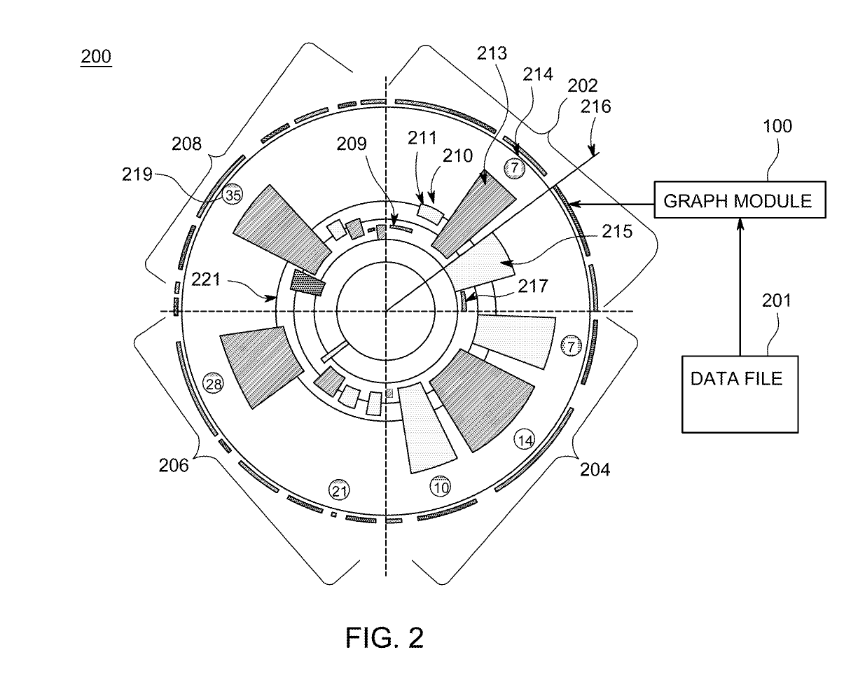

FIG. 2 is an illustration of an RTS graph 200 for a football game in accordance with exemplary embodiments of the present inventions.

A data file 201 is parsed by the graph module 100. The graph module 100 processes each of the data elements in the data file 201. In this embodiment, the data file 201 comprises a listing of each drive in the first SuperBowl® in 1967. The data file 201 may comprise how many yards each team gained during each drive, the length of time for each drive, and what type of play was associated with each drive.

The graph module 100 takes the length of the game (e.g. 60 minutes) and maps the length to the graph 200. The graph module 100 segments the RTS graph 200 into four quadrants, quadrant 202, quadrant 204, quadrant 206 and quadrant 208, each representing a quarter (15 minutes) of the game for a total of 60 minutes. Each drive when the team has possession is represented as a sector 209, corresponding to the sectors 110 in FIG. 1 and have identifiers corresponding to identifiers 124. Each sector is displayed as a widening bar, with a length according to the length of the drive. The radial extents of the RTS graph 200 indicate the yards gained in each drive, from 0 to 100 yards in distance (i.e., the size of a football field). In some embodiments, there may be a portion of radial extent before the 0^{th} yard to indicate a safety or the like. If any of the teams scored a touchdown, the sector representing that drive reaches out to the furthest circle from the original point of the RTS graph 200 and indicates a touchdown using the letter “TD”. In this example, the furthest extent leaves room for the touchdown identifier 210. In some embodiments, as shown in FIG. 2, the identifier 210 may comprise a magnitude associated with the identifier, e.g. 7 points were gained with the touchdown.

According to some embodiments, the data file 201 may be a comma separated value (CSV) file, an extensible markup language (XML) file, or may be relational data from a database. In exemplary embodiments, the data file 201 comprises a quarter number, a beginning time of the drive and an ending time of the drive, how many points were scored during the drive, which yard the drive started at, the team with the ball and the result of the drive. If several RTS graphs were generated for several games, the data file 201 may comprise a field indicating an identification number for each unique game.

Each team is represented by the use of a different color, a differing identifying pattern, or the like. As shown in FIG. 2, the Kansas City Chiefs are shown by the red color, while the Green Bay Packers are shown in green. The game begins in quadrant (or quarter) 202 with the packers receiving a kickoff at 25 yards and getting pushed backwards to the twenty two yard line. At the 22 yard line, the Packers punt the ball, as indicated by identifier 210 (“P”). Sector 211 shows the Chiefs receiving the punt at the 37 yard line and eventually driving the ball to the 48 yard line, before punting it to the Packers. Sector 213 shows the Packers receiving the punt at the seven yard line and driving for a touchdown to score seven points identified by identifier 214.

As the time advances to 5:54 minutes left in the quarter, indicated by line 216, the Chiefs receive a kickoff at the thirteen yard line. The drive ends at the 67 yard line with a punt to the Packers. The Packers receive the ball at the 20 yard line and advance it to the 23 yard line, after which the quarter ends as the sectors have reached quadrant 204. Each quarter proceeds similarly, where after each touchdown, the indicators are updated to reflect the total score for each team. For example, the indicator 219 shows the final score for the Packers as 35 after the touchdown shown by that sector. Other identifies may specify that an interception occurs, e.g. “I” at indicator 221. Those of ordinary skill in the art will recognize that any other types of play results can be indicated in the identifiers, e.g., a field goal (“FG”) or the like.

In this example, no video footage of SuperBowl I is available for viewing today, however the data corresponding to each drive exists because the game was annotated. Using the annotations stored as data file 201, the graph module 100 can not only construct the RTS graph 200 allowing a user to visualize the game in a cohesive manner, the graph module 100 can animate the plotting on the RTS graph 200 to emulate (for example, in a fraction of the time), the progression of the game according to predetermined times, selectable by a viewer of the graph.

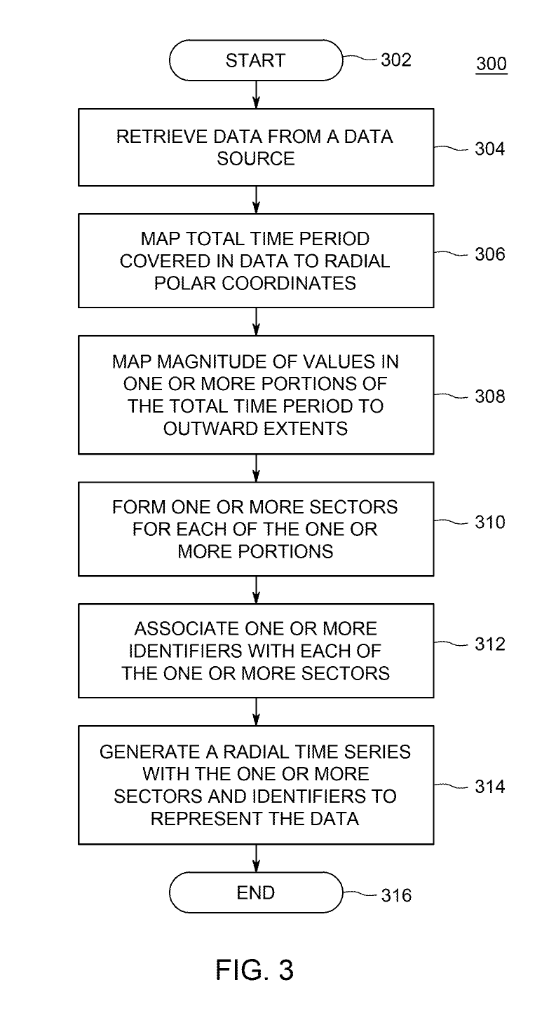

FIG. 3 is a flow diagram illustrating a method 300 for generating a radial time series in accordance with exemplary embodiments of the present invention. Method 300 illustrates an exemplary flow of the graph module 100 stored in memory 154 and executed by the processor 152 of computer system 150.

The method begins at step 302 and proceeds to step 304. At step 304, data is received from a data source. The data source may be a relational database, a simple binary or non-binary data file, a non-relational database or the like. The data may represent magnitudes associated with actors over a particular period of time, each record indicating a period of time, and a magnitude of activity for each actor, and the result of the activity. Those of ordinary skill in the art will recognize that other fields are possible and no limitation is made.

At step 306, the total time period of the data is mapped to radial polar coordinates, e.g., the earliest time the data is recorded is equated to 0 degrees in the RTS graph and progresses to 360 degrees which is mapped to the final time indicated in the graph.

At step 308, the magnitude of values associated with each actor or portions of time are mapped to a radial extent, where the minimum magnitude values appear at the radial extent closes to the origin point of the RTS graph while increasing magnitude values extend outward from the origin point.

At step 310, one or more sectors are formed for each actor or portion for a period of time in the data source. For example, if the data file indicates that from Jun. 1^{st}, 2012 to Jun. 31^{nd} 2012, sales were $100,000, and this was the lowest sales number of an entire year, one sector would be formed for the period of Jun. 1^{st}, 2012 to Jun. 2^{nd} 2012, occupying approximately 1/12^{th} of polar region of the RTS graph. In another example, if the data file contains sporting event information such as a football game, the data may indicate that in the first quarter, from 11 minutes to 5 minutes left in the quarter, one team gained 40 yards in a drive, out of a possible 100 yards. The sector would be formed based on the percentage of time taken in the drive as compared to the entire game, while the magnitude would extend to “40” relative to the maximum magnitude value of 100.

At step 312, identifiers are associated witch each of the one or more sectors. For example, the value 40 yards forms an identifier associated with the sector of time (shown as a bar, for example) showing the game from 11 minutes to 5 minutes left in the first quarter. The identifier indicates that from the 11 minute mark to the 5 minute mark, the team advanced by 40 yards in one drive. Another identifier associated with that particular sector may be the result of the drive—for example a “P” may indicate a punt, and a “FG” may indicate that at the end of the 40 yard drive, a field goal was attempted.

At step 314, a radial time series graph is generated where the one or more sectors are displayed with the identifiers to represent the data retrieved from the data source. The radial time series graph allows a user to view all data in an intuitive and useful manner. The method terminates at step 316.

While the foregoing is directed to embodiments of the present invention, other and further embodiments of the invention may be devised without departing from the basic scope thereof.

1. A method for visualizing data corresponding to a sporting event, comprising:
receiving data corresponding to a sporting event, wherein the data comprises at least time one or more specified times during the sporting event, a magnitude associated with each of the one or more specified times, and a team associated with the magnitude;
mapping a total time period captured in the data to polar coordinates, where a beginning of play in the sporting event is zero degrees and an end of play in the sporting event is 360 degrees, the polar coordinates displayed in a radial time series;
mapping a maximum of the magnitude to a maximum outward extent;
mapping each magnitude at the one or more specified times onto the radial time series at a corresponding degree;
distinguishing the magnitude by the team corresponding to the magnitude; and
displaying the radial time series.

2. The method of claim 1, further comprising:
displaying the magnitude as a bar extending towards the maximum outward extent, wherein the magnitude extends according to its proportion to the maximum outward extend;
displaying an identifier corresponding to one or more of the team and the magnitude value, adjacent or overlapping the bar; and
displaying an indication when one or more points are scored according to a time the one or more points were scored.

3. The method of claim 2, wherein the data represents data recorded for an entire football game, comprising yards gained by a team on each drive, length of time elapsed on the drive, whether or not a touchdown was scored on the drive and whether or not an interception occurred on the drive.

4. The method of claim 3, wherein the radial time series is divided into four quadrants, each representing a quarter of a football game.

5. The method of claim 4, wherein the radial time series from an origin point to the maximum outward extent represents distance on a football field.

6. The method of claim 5, wherein each drive of the game is shown according to elapsed time in the game as the bar, and the length of the bar indicates yards gained by the team with possession of a football during that drive.

7. The method of claim 6, further comprising:
animating the display of each drive according to a first predetermined time; and
animating the display of each bar for each drive, according to a second predetermined time.

8. The method of claim 7, further comprising:
receiving user input on the radial time series;
determining a selected drive that the user input corresponds to; and
displaying detailed information corresponding to the selected drive.

9. An apparatus for visualizing data corresponding to a sporting event, executing, via one or more processors, a graph module that performs a method comprising:
receiving data corresponding to a sporting event, wherein the data comprises at least time one or more specified times during the sporting event, a magnitude associated with each of the one or more specified times, and a team associated with the magnitude;
mapping a total time period captured in the data to polar coordinates, where a beginning of play in the sporting event is zero degrees and an end of play in the sporting event is 360 degrees, the polar coordinates displayed in a radial time series;
mapping a maximum of the magnitude to a maximum outward extent;
mapping each magnitude at the one or more specified times onto the radial time series at a corresponding degree;
distinguishing the magnitude by the team corresponding to the magnitude; and
displaying the radial time series.

10. The method of claim 9, further comprising:
displaying the magnitude as a bar extending towards the maximum outward extent, wherein the magnitude extends according to its proportion to the maximum outward extend;
displaying a label corresponding to the team adjacent or overlapping the bar; and
displaying an indication on when one or more points are scored in data.

11. The method of claim 9, wherein the data represents data recorded for an entire football game, comprising yards gained by a team on each drive, length of time elapsed on the drive, whether or not a touchdown was scored on the drive and whether or not an interception occurred on the drive.

12. The method of claim 11, wherein the radial time series is divided into four quadrants, each representing a quarter of a football game.

13. The method of claim 12, wherein the radial time series from an origin point to the maximum outward extent represents distance on a football field.

14. The method of claim 13, wherein each drive of the game is shown according to elapsed time in the game as the bar, and the length of the bar indicates yards gained by the team with possession of a football during that drive.

15. The method of claim 14, further comprising:
animating the display of each drive according to a first predetermined time; and
animating the display of each bar for each drive, according to a second predetermined time.

16. The method of claim 15, further comprising:
receiving user input on the radial time series;
determining a selected drive the user input corresponds to; and
displaying detailed information corresponding to the selected drive.
